(19) United States
(12) Patent Application Publication
(10) Pub. No.: US 2024/0383463 A1
(43) Pub. Date: Nov. 21, 2024

(54) ANTI-LOCK BRAKING SYSTEM TONE RING APPARATUS

(71) Applicant: Consolidated Metco, Inc., Vancouver, WA (US)

(72) Inventors: Willow Pileggi, Portland, OR (US); Conor Crowley, Spokane, WA (US)

(21) Appl. No.: 18/663,719

(22) Filed: May 14, 2024

Related U.S. Application Data
(60) Provisional application No. 63/467,519, filed on May 18, 2023.

(51) Int. Cl. B60T 17/22; B60B 27/00; F16D 65/12

(52) U.S. Cl. CPC B60T 17/22; B60B 27/0052; B60B 27/0068; F16D 65/123; B60B 2310/316; B60B 2320/10; B60B 2900/111; B60B 2900/113; B60B 2900/321; B60B 2900/513; B60B 2900/541; B60T 2240/00

(57) ABSTRACT

In one aspect, an anti-lock braking system (ABS) tone ring apparatus for a wheel end system. The ABS tone ring apparatus includes a body, a tone ring portion of the body to interact with an ABS sensor, and a mounting portion of the body configured to be clamped between components of the wheel end system. The mounting portion includes a plurality of through openings configured to receive studs of the wheel end system that extend between the components as the components clamp the mounting portion of the body therebetween.

### CROSS-REFERENCE TO RELATED APPLICATION

This application claims benefit of U.S. Provisional Application No. 63/467,519, filed May 18, 2023, which is hereby incorporated herein by reference in its entirety.

### FIELD

This disclosure relates to anti-lock braking systems and, more specifically, relates to tone rings for anti-lock braking systems.

### BACKGROUND

Anti-lock braking systems (ABS) of vehicles utilize a tone ring that rotates with rotation of a wheel and a sensor that detects the rotation of the tone ring. A controller of the ABS system monitors the rotation of the wheel and operates the ABS system in response to the wheel starting to skid as the vehicle brakes.

Some commercial vehicles, such as tractor-trailers and commercial trucks such as box trucks, have flat brake rotors with an ABS tone ring mounted to an inboard side of a brake rotor. Mounting the ABS tone ring to the rotor exposes the ABS tone ring to harsh environmental conditions, corrosion buildup, and extreme temperatures that can lead to premature failure. Another issue is rust jacking, where corrosion builds up on the brake rotor and forces the ring off of the brake rotor.

### SUMMARY

In one aspect of the present disclosure, an anti-lock braking system (ABS) tone ring apparatus is provided for a wheel end system. The ABS tone ring apparatus includes a body, a tone ring portion of the body to interact with an ABS sensor, and a mounting portion of the body configured to be clamped between components of the wheel end system. The mounting portion includes a plurality of through openings configured to receive studs of the wheel end system that extend between the components as the components clamp the mounting portion of the body therebetween. The ABS tone ring apparatus connects the tone ring portion to the components of the wheel end system via the clamping of the mounting portion between the components while positioning the tone ring portion to be sensed by an ABS sensor.

In another aspect of the present disclosure, a wheel end system is provided that includes a wheel hub, a brake rotor to be mounted to a wheel hub, and an anti-lock braking system (ABS) tone ring apparatus. The ABS tone ring apparatus includes a mounting portion configured to be clamped between the wheel hub and the brake rotor. The ABS tone ring apparatus further includes a tone ring portion positioned to be sensed by an ABS sensor with the mounting portion clamped between the wheel hub and the brake rotor. The mounting portion may thereby be securely clamped between the wheel hub and the brake rotor, which may fix the mounting portion to the wheel hub and brake rotor with more than 100,000 pounds of force for a commercial vehicle, while the tone ring portion is positioned to be sensed by an ABS sensor.

In another aspect of the present disclosure, a method is provided that includes positioning studs of a wheel end system in through openings of a mounting portion of a support of an anti-lock brake (ABS) tone ring apparatus. The method includes securing the mounting portion of the support between components of the wheel end system. The method further includes connecting a sensor ring to the support secured between the components of the wheel end system.

### BRIEF DESCRIPTION OF THE DRAWINGS

FIG. 1 is a perspective view of a wheel end system including a wheel hub, a brake rotor, and an ABS tone ring apparatus;

FIG. 2 is a cross-sectional view of the wheel end system taken across line 2-2 in FIG. 1 and showing the ABS tone ring apparatus at an inboard end of the wheel end system;

FIG. 3 is an enlarged and rotated view of the area in the dashed rectangle of FIG. 2 showing a flange of the ABS tone ring apparatus clamped between the brake rotor and a body of the wheel hub;

FIG. 4 is a perspective view of the ABS tone ring apparatus of FIG. 1 showing a sensor ring and a support of the ABS tone ring apparatus;

FIG. 5 is an end elevational view of the ABS tone ring apparatus of FIG. 4 showing the flange of the support having through openings to receive studs of the wheel hub;

FIG. 6 is an exploded view of the ABS tone ring apparatus of FIG. 4 showing a connecting portion of the support configured to form a press-fit connection with the sensor ring; and

FIG. 7 is a partial exploded view of the wheel end system of FIG. 1 showing the support, brake rotor, nuts, and sensor ring positioned to be connected to the wheel hub.

### DETAILED DESCRIPTION

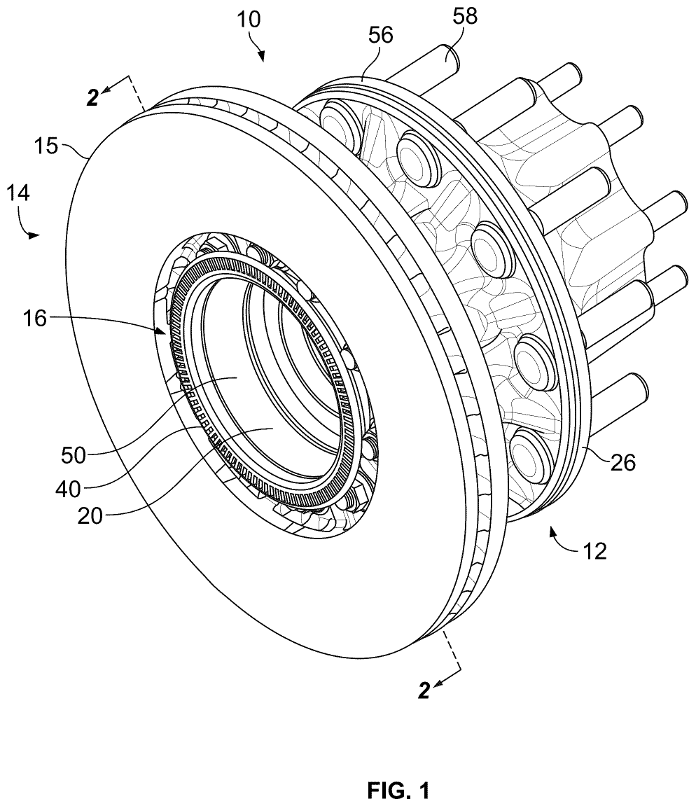

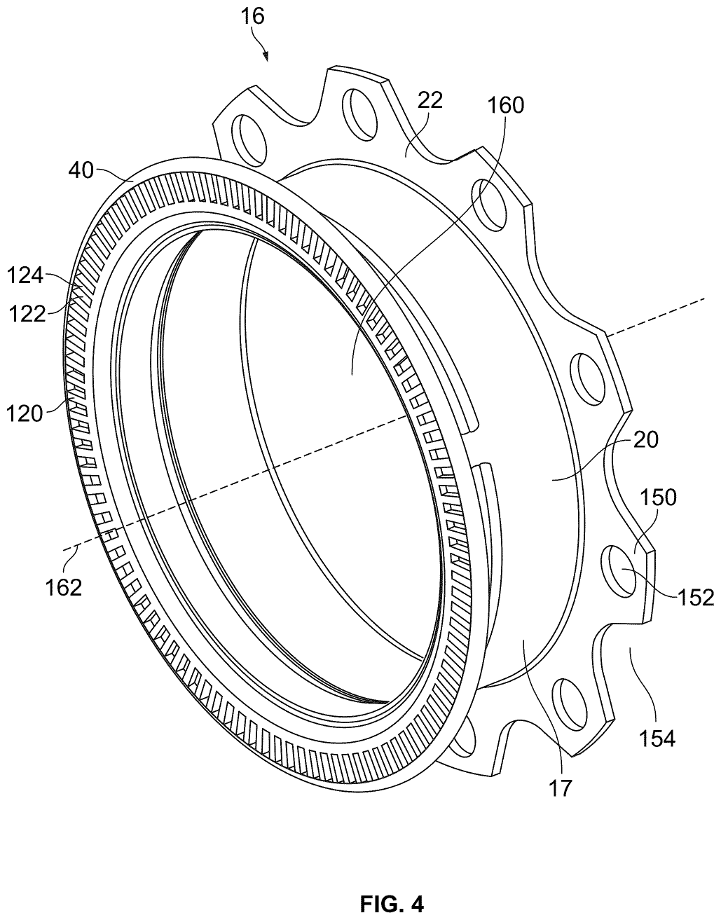

Regarding FIG. 1, a wheel end system 10 is provided for a commercial vehicle such as a tractor, trailer, or box truck. Commercial vehicles that may utilize the wheel end system 10 include commercial vehicles in classes four through eight as classified by the Federal Highway Administration. The wheel end system 10 includes a wheel hub 12 and a brake assembly 14 connected thereto. The brake assembly 14 includes a brake rotor 15 and an ABS tone ring apparatus 16. With reference to FIG. 4, the ABS tone ring apparatus 16 has a body 17 that includes a support 20 and a sensor ring 40. The support 20 and sensor ring 40 are distinct parts that are connected during assembly of the brake rotor 15 and wheel hub 12.

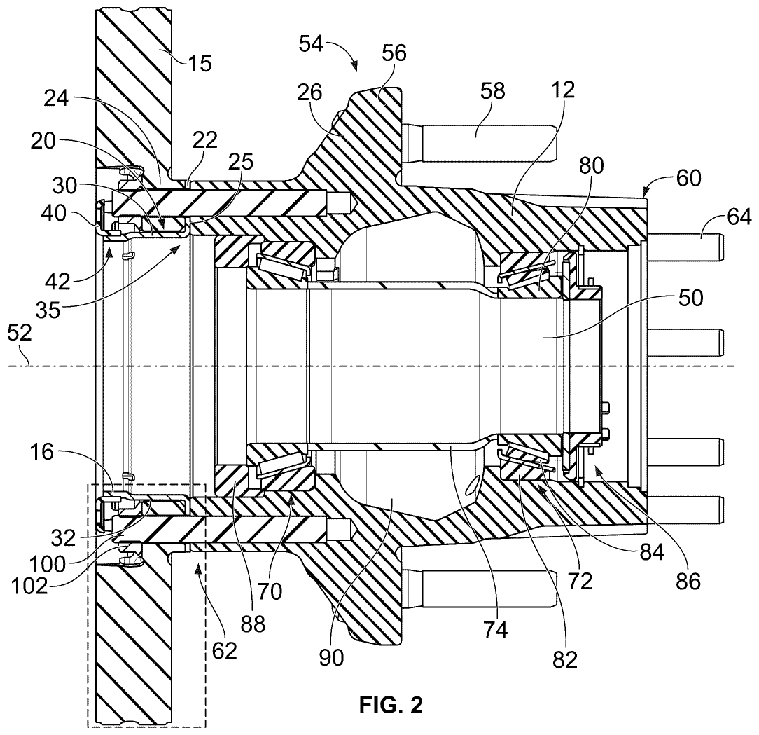

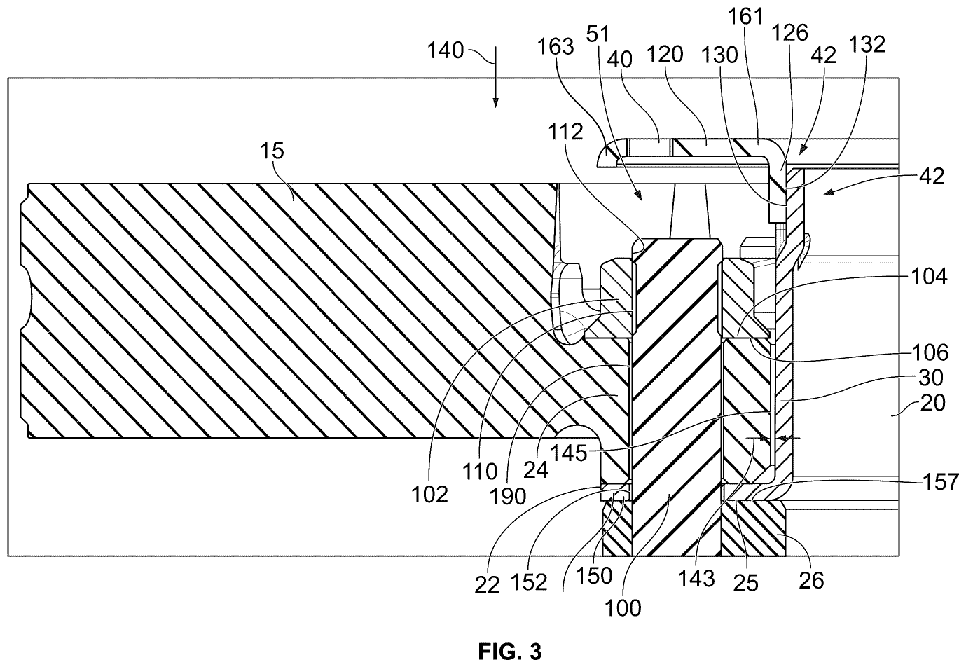

Regarding FIGS. 3 and 4, the support 20 has a mounting portion, such as a flange 22, clamped between a central portion 24 of the brake rotor 15 and an inboard end surface 25 of a wheel hub body 26 of the wheel hub 12. For commercial vehicles, the brake rotor 15 and wheel hub body 26 are urged together with forces in excess of 100,000 pounds, such as 250,000 pounds. Because the brake rotor 15 and wheel hub body 26 clamp the flange 22 therebetween with significant force, water is unable to wick into a joint 35 (see FIG. 2) formed by the brake rotor 15, flange 22, and wheel hub body 26. In this manner, the clamping of the flange 22 between the brake rotor 15 and wheel hub body 26 inhibits corrosion of the joint 35.

With reference to FIG. 2, the sensor ring 40 is on an inboard side of the brake rotor 15 while the flange 22 is on an outboard side of the brake rotor 15. The support 20 includes a spacer portion, such as an axial wall portion 30, extending in a central opening 32 of the brake rotor 15. The ABS tone ring apparatus 16 extends in a generally cantilevered manner from the flange 22 held between the brake rotor 15 and the wheel hub body 26 to the sensor ring 40. In this manner, the support 20 positions the sensor ring 40 inboard of the central portion 24 of the brake rotor 15 so that rotation of the sensor ring 40 may be detected by a sensor of an ABS system of the vehicle that includes the wheel end system 10.

Regarding FIG. 3, the sensor ring 40 is spaced in axial and radial directions from the brake rotor 15 such that an air gap 51 insulates the sensor ring 40 from the high temperatures experienced by the brake rotor 15. The air gap 51 has a generally annular shape and extends around and outboard of the sensor ring 40. The air gap 51 improves the durability of the sensor ring 40 by reducing the peak temperatures experienced by the sensor ring 40 as compared to directly mounting an ABS tone ring to the brake rotor 15. Further, the support 20 is made of a material selected to thermally insulate the sensor ring 40 from the brake rotor 15. For example, the support 20 may be made of stainless steel and the wheel hub body 26 may be made of aluminum. The lower thermal conductivity of the stainless steel support 20 reduces the heat conducted to the sensor ring 40 which further improves the durability of the sensor ring.

In one embodiment, the ABS tone ring apparatus 16 includes a releasable connection 42 between the ABS tone ring sensor ring 40 and the support 20 as shown in FIGS. 2 and 3. In one example, the releasable connection 42 is a press-fit connection that permits the sensor ring 40 to be connected to the support 20 after the brake rotor 15 and the support 20 have been secured to the wheel hub 12. Further, the sensor ring 40 may be disconnected from the support 20 and replaced in the event of fouling of the sensor ring 40 without having to disassemble the brake rotor 15 and support 20 from the wheel hub 12. For example, a pry bar may be used to disengage the sensor ring 40 from the support 20.

Regarding FIGS. 1 and 2, the wheel end system 10 has a central opening 50 to receive a spindle of a vehicle. The brake rotor 15, wheel hub body 26, and ABS tone ring apparatus 16 are rotatable about the central axis 52. The wheel hub 12 includes a wheel mounting portion 54 such as a flange 56 and wheel studs 58 to receive a wheel. Regarding FIG. 2, the wheel hub 12 includes an outboard end portion 60 and an inboard end portion 62. In the embodiment of FIG. 2, the outboard end portion 60 of the wheel hub 12 includes drive flange studs 64 for receiving a drive flange of a drive shaft. In another embodiment, the wheel hub 12 is for a non-drive wheel such as a trailer wheel, and the wheel hub 12 does not include the drive flange studs 64.

The wheel hub 12 includes an inboard bearing assembly 70, outboard bearing assembly 72, and spacer 74 maintaining a predetermined spacing between inboard and outboard bearing assemblies 70, 72 along the axis of rotation 52 of the wheel hub 12. Each of the inboard and outboard bearing assemblies includes a cone 80, a cup 82, and roller bearings 84 that rotatably support the cup 82 on the cone 80. The cones 80 of the inboard and outboard bearing assemblies 70, 72 are fixed to the spindle and the wheel hub 12 includes a spindle nut assembly 86 for securing the wheel hub 12 to the spindle. The wheel hub 12 further includes a seal 88 for retaining lubricant in the wheel hub 12. In one embodiment, the wheel hub body 26 includes a grease pocket 90 that stores lubricant and permits the lubricant to contact the inboard and outboard bearing assemblies 70, 72.

Regarding FIG. 3, the wheel hub 12 includes studs 100 that extend in an inboard direction from the inboard end surface 25 of the wheel hub body 26. The wheel hub 12 further includes nuts 102 each having a surface 104 that engages in an inboard surface 106 of the central portion 24 of the brake rotor 15 as the installer tightens down the nuts 102. The nuts 102 have female threads 110 that engage male threads 112 of the corresponding stud 100.

With reference to FIG. 4, the sensor ring 40 includes a tone ring portion 120 having an alternating arrangement of openings 122 (see FIG. 4) and interacting members such as radial struts 124. The signal generated by the ABS sensor from the alternating openings 122 radial struts 124 as the sensor ring 40 rotates with the wheel is used by the controller of the ABS system to detect the angular velocity, acceleration, direction of motion, etc. of the wheel associated with the sensor ring 40.

Regarding FIG. 3, the sensor ring 40 includes a collar, such as an axial wall portion 126. The axial wall portion 126 of the sensor ring 40 initially has a radially inner surface 130 with an inner diameter slightly larger than an initial outer diameter of a radially outer surface 132 of the axial wall portion 30 of the support 20. In this manner, the sensor ring 40 and support 20 form a press-fit connection when the annular wall portion 126 of the sensor ring 40 is urged in direction 140 onto the axial wall portion 30 of the support 20. Further, the radially outer surface 132 may have a smaller outer diameter than an outboard portion of the axial wall portion 30 to facilitate advancing of the brake rotor 15 around the axial wall portion 30 and into position against the flange 22.

In one embodiment, the axial wall portion 30 of the support 20 is spaced radially inward a distance 143 from a radially inner surface 145 of the brake rotor 15 such that there is a spacing between the axial wall portion 30 and the brake rotor 15 as shown in FIG. 3. The spacing between the axial wall portion 30 of the support 20 and the brake rotor 15 reduces conductive heat transfer between the brake rotor 15 and support 20 and reduces heat transfer between the support 20 and the sensor ring 40.

Regarding FIGS. 3 and 4, the flange 22 of the support 20 includes one or more flange portions 150 with through openings 152. The support 20 has recesses 154 between the flange portions 150 that permit the flange portions 150 to flatten during clamping of the flange portions 150 between the brake rotor 15 and wheel hub body 26. In other words, the recesses 154 enable the flange portions 150 to seat fully against the brake rotor 15 and wheel hub body 26 and provide flat bearing surfaces that are engaged by the brake rotor 15 and wheel hub body 16.

Further, the recesses 154 reduce the weight of the support 20 and the moment of inertia of the support 20 about a central axis 162 of the ABS tone ring apparatus 16. The reduced weight and reduced moment of inertia of the support 20 makes the ABS tone ring apparatus 16 easier to rotate and improves the efficiency of the wheel end system 10.

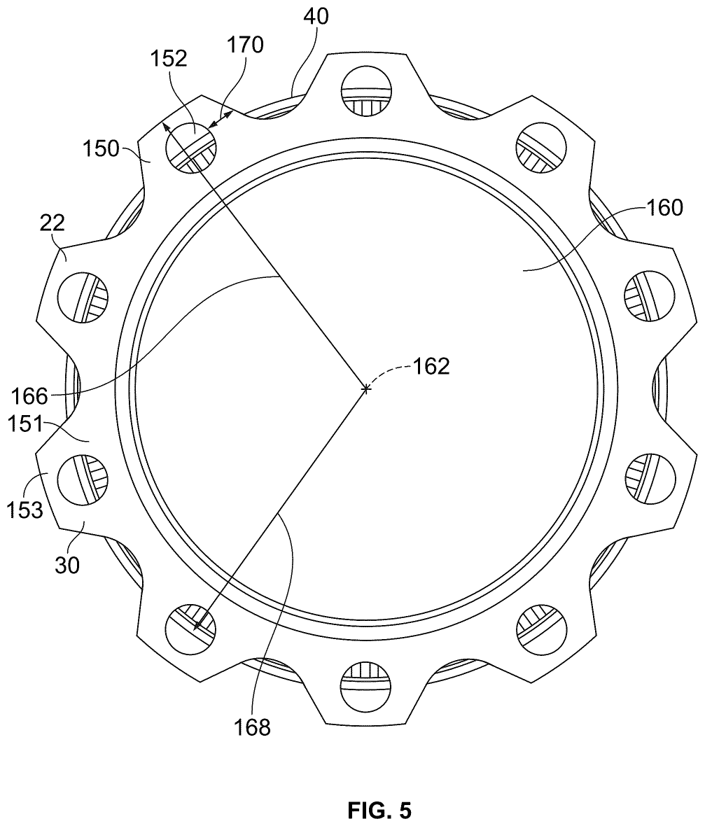

With reference to FIGS. 4 and 5, the ABS tone ring apparatus 16 has a central opening 160 sized to receive a vehicle spindle therein. The flange portions 150 have a maximum outer radius 166 that is greater than a maximum outer radius 168 of the sensor ring 40. The larger maximum outer radius 166 provides additional surface area for the flange portions 150 to receive the clamp force while the smaller maximum outer radius 168 enables the sensor ring 40 to fit within a tighter envelope on the inboard face of the disc rotor 15. Each flange portion 150 has a base portion 151 and a free end portion 153 as shown in FIG. 5, whereas the sensor ring 40 has a base portion 161 and a free end portion 163 as shown in FIG. 3. The properties of the flange 22, such as material of the support 20, the thickness of the flange portions 150, the shape of the flange portions 150, the radial extent of the flange portions 150, and a minimal width 170 of the flange portions 150 about the through openings 152, are selected to withstand the 100,000 pounds or greater clamping force between the brake rotor 15 and the wheel hub 12.

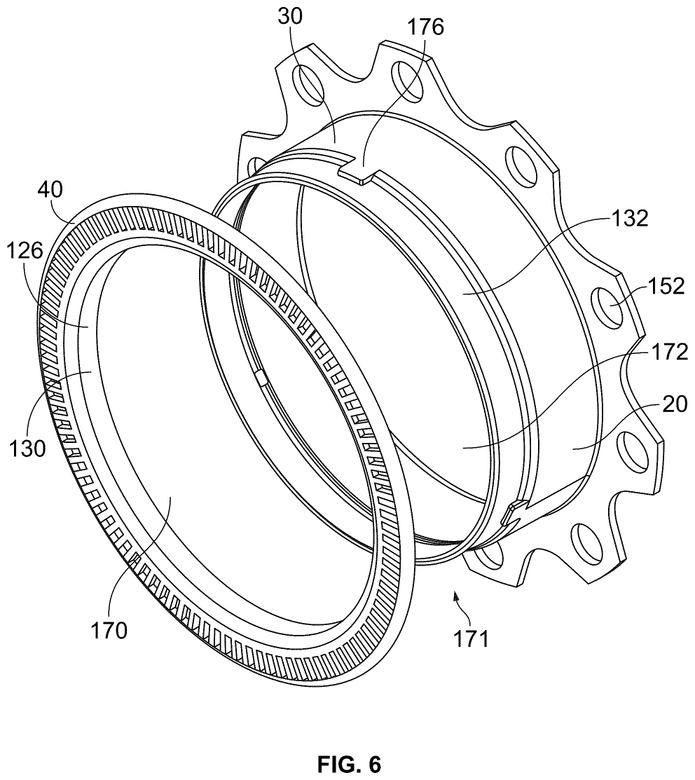

Regarding FIG. 6, the sensor ring 40 has a central opening 170 that is coaxially aligned with a central opening 172 of the support 20 when the sensor ring 40 and support 20 are connected. The support 20 has a connecting portion 171 to engage the sensor ring 40. The connecting portion 171 may be configured to form a releasable or permanent connection with the sensor ring 40. In the embodiment of FIG. 6, the connecting portion 171 includes the axial wall portion 30 which may include one or more protrusions, such as interference tabs 176, that provide localized increases in the outer diameter of the axial wall portion 30 to deform the axial wall portion 126 of the sensor ring 40 as the sensor ring 40 is press-fit onto the support 20.

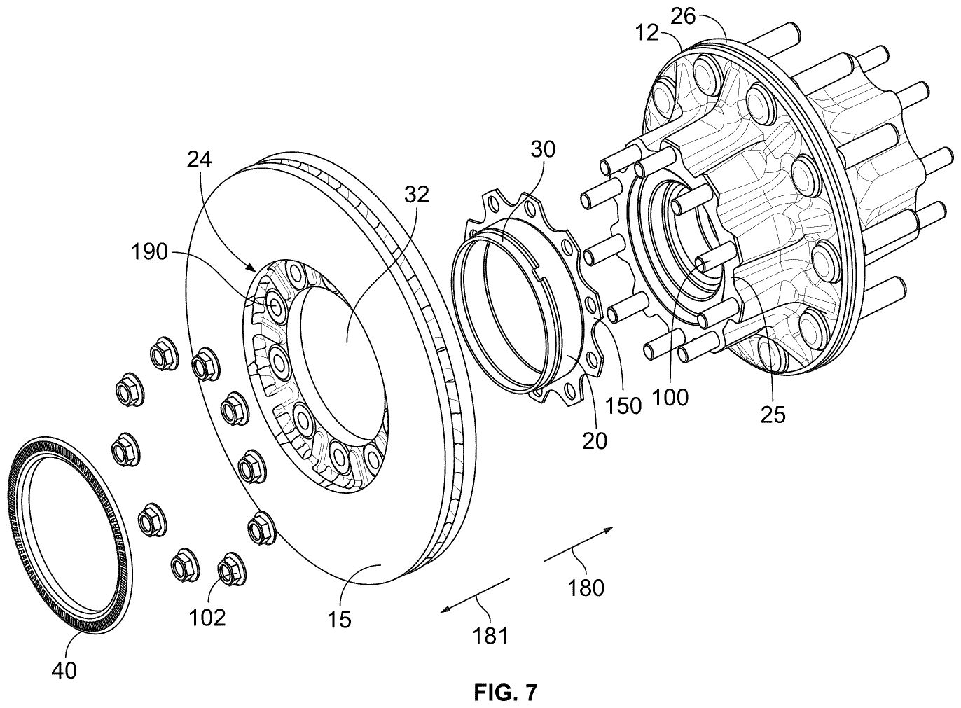

Regarding FIG. 7, to assemble the ABS tone ring apparatus 16, the brake rotor 15 and the wheel hub 12, the support 20 is positioned to align the through openings 152 of the support 20 with the studs 100 of the wheel hub 12. The support 20 is advanced in direction 180 to seat an outboard surface portion 157 (see FIG. 3) of the flange portions 150 of the support 20 against the inboard end surface 25 of the wheel hub body 26. Next, the brake rotor 15 is clocked to align through openings 190 of the central portion 24 of the brake rotor 15 with the studs 100. The brake rotor 15 is then moved in direction 180 to position the studs 100 in the through openings 190 of the brake rotor 15. Next, the nuts 102 are threaded onto the studs 100 and tightened down to tightly urge the central portion 24 of the brake rotor 15 against the support 20, which was previously seated on the wheel hub 12. Once the nuts 102 have been tightened down, the tone ring 40 is press-fit in direction 180 onto the axial wall portion 30 of the support 20. In the event the tone ring 40 is fouled or otherwise damaged, the tone ring 40 may be urged in opposite direction 181 to disengage the press-fit connection with the support 20. A new sensor ring 40 may then be connected to the support 20 without having to disconnect the nuts 102 and remove the brake rotor 15 from the wheel hub 12.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims. For example, in one embodiment the ABS tone ring apparatus 16 may have a flange 22 configured to be clamped between different components of the wheel end system 10, such as the nuts and brake rotor of a wheel end system. As another example, the sensor ring 40 and the support 20 may have a unitary, one-piece construction instead of being an assembly of distinct parts.

What is claimed is:

1. An anti-lock braking system (ABS) tone ring apparatus for a wheel end system, the ABS tone ring apparatus comprising:
a body;
a tone ring portion of the body to interact with an ABS sensor;
a mounting portion of the body configured to be clamped between components of the wheel end system; and
a plurality of through openings of the mounting portion of the body configured to receive studs of the wheel end system that extend between the components as the components clamp the mounting portion of the body therebetween.

2. The ABS tone ring apparatus of claim 1 wherein the body is rotatable around a central axis; and
wherein the mounting portion of the body includes a flange extending radially outward to be clamped between the components of the wheel end system, the flange including the through openings.

3. The ABS tone ring apparatus of claim 1 wherein the mounting portion comprises a plurality of flange portions spaced apart from one another about the body; and
wherein each of the flange portions have at least one of the through openings formed therein.

4. The ABS tone ring apparatus of claim 1 wherein the body includes a releasable connection for connecting the tone ring portion and the mounting portion, the releasable connection configured to permit the tone ring portion to be disconnected from the mounting portion while the mounting portion is clamped between the components of the wheel end system.

5. The ABS tone ring apparatus of claim 1 wherein the body comprises a support including the mounting portion of the body;
wherein the body comprises a sensor ring to be connected to the support, the sensor ring including the tone ring portion; and
wherein the support is rotatable around a central axis, the support including an axial spacer portion that provides an axial spacing between the tone ring portion and the mounting portion when the sensor ring is connected to the support.

6. The ABS tone ring apparatus of claim 1 wherein the body comprises a support including the mounting portion;
wherein the body comprises a sensor ring including the tone ring portion; and
wherein the support and the sensor ring have annular wall portions configured to form a press-fit connection between the support and the sensor ring.

7. The ABS tone ring apparatus of claim 1 wherein the body has a central opening to receive a vehicle spindle and an axis of rotation extending through the central opening; and
wherein the through openings are radially outward of the central opening.

8. The ABS tone ring apparatus of claim 1 wherein the body is rotatable around a central axis and the tone ring portion and the mounting portion have a spacing therebetween along the central axis to receive one of the components between the tone ring portion and the mounting portion;
wherein the body includes a spacer portion for connecting the tone ring portion and the mounting portion; and
wherein the mounting portion extends radially outward from the spacer portion of the body.

9. The ABS tone ring apparatus of claim 8 wherein the spacer portion of the body is annular.

10. The ABS tone ring apparatus of claim 1 wherein the body is rotatable around a central axis; and
wherein the mounting portion includes a flange having a flange base portion and a flange free end portion, the flange free end portion radially outward of the flange base portion.

11. The ABS tone ring apparatus of claim 10 wherein the tone ring portion includes a tone ring base portion and a tone ring free end portion, the tone ring free end portion radially outward of the tone ring base portion.

12. The ABS tone ring apparatus of claim 1 wherein the mounting portion extends radially outward of the tone ring portion of the body; and
wherein at least a portion of each of the through openings are radially outward of the tone ring portion of the body.

13. The ABS tone ring apparatus of claim 1 wherein the tone ring portion includes a first material and the mounting portion includes a second material having a lower thermal conductivity than the first material.

14. The ABS tone ring apparatus of claim 1 in combination with the components, the components comprising:
a brake rotor; and
a nut or a wheel hub body.

15. The ABS tone ring apparatus of claim 1 wherein the through openings are circular.

16. A wheel end system comprising:
a wheel hub;
a brake rotor to be mounted to the wheel hub;
an anti-lock braking system (ABS) tone ring apparatus comprising:
a mounting portion configured to be clamped between the wheel hub and the brake rotor; and
a tone ring portion positioned to be sensed by an ABS sensor with the mounting portion clamped between the wheel hub and the brake rotor.

17. The wheel end system of claim 16 wherein the mounting portion of the ABS tone ring apparatus includes through openings to receive studs of the wheel hub.

18. The wheel end system of claim 16 wherein the ABS tone ring apparatus comprises a releasable connection between the mounting portion and the tone ring portion.

19. The wheel end system of claim 16 wherein the ABS tone ring apparatus has a spacing between the mounting portion and the tone ring portion sized to receive a portion of the brake rotor therein.

20. The wheel end system of claim 16 wherein the ABS tone ring apparatus comprises:
a sensor ring including the tone ring portion, the sensor ring made of a first material; and
a support including the mounting portion, the support made of a second material having a thermal conductivity lower than the first material.

21. The wheel end system of claim 16 wherein the brake rotor includes a central opening and through openings for receiving studs of the wheel hub disposed about the central opening; and
wherein the ABS tone ring apparatus includes a spacer portion for connecting the mounting portion and the tone ring portion, the spacer portion configured to extend in the central opening of the brake rotor with the mounting portion clamped between the wheel hub and the brake rotor.

22. The wheel end system of claim 16 wherein the brake rotor includes a central portion having through openings to receive studs of the wheel hub; and
wherein the mounting portion and the tone ring portion of the ABS tone ring apparatus are on opposite sides of the central portion of the brake rotor with the mounting portion of the ABS tone ring apparatus clamped between the brake rotor and the wheel hub.

23. The wheel end system of claim 16 wherein the wheel hub includes a wheel mounting portion;
wherein the brake rotor is inboard of the wheel mounting portion with the brake rotor mounted to the wheel hub; and
wherein the tone ring portion of the ABS tone ring apparatus is inboard of the brake rotor with the mounting portion of the ABS tone ring apparatus clamped between the brake rotor and the wheel hub.

24. The wheel end system of claim 16 wherein the mounting portion of the ABS tone ring apparatus includes a plurality of spaced apart flange portions each having a through opening formed therein to receive a stud of the wheel hub.

25. The wheel end system of claim 16 wherein the wheel hub includes threaded studs; and
wherein the mounting portion of the ABS tone ring apparatus includes through openings to receive the threaded studs, the wheel end system further comprising:
nuts configured to threadingly engage the studs of the wheel hub and urge the brake rotor and the wheel hub together.

26. A method of assembling a wheel end system, the method comprising:
positioning studs of the wheel end system in through openings of a mounting portion of a support of an anti-lock braking system (ABS) tone ring apparatus;
securing the mounting portion of the support between components of the wheel end system; and
connecting a sensor ring to the support secured between the components of the wheel end system, the sensor ring including a tone ring portion for interacting with an ABS sensor.

27. The method of claim 26 wherein the components of the wheel end system include a wheel hub body and a brake rotor; and
wherein securing the mounting portion of the support between the components includes securing the support between the wheel hub body and the brake rotor.

28. The method of claim 26 wherein the components of the wheel end system include a wheel hub body and a brake rotor; and
wherein securing the mounting portion of the support between the components of the wheel end comprises:
positioning the mounting portion of the support between the wheel hub body and the brake rotor; and
positioning a spacer portion of the ABS tone ring in a central opening of the brake rotor.

29. The method of claim 26 wherein connecting the sensor ring to the support comprises engaging a press-fit connection between the sensor ring and the support.

30. The method of claim 26 wherein securing the support between the components of the wheel end system includes clamping the mounting portion of the support between the components.

31. The method of claim 30 wherein connecting the sensor ring to the support comprises connecting the sensor ring to the support while the mounting portion of the support is clamped between the components of the wheel end system.
